(19) United States
(12) Patent Application Publication
(10) Pub. No.: US 2008/0101416 A1
(43) Pub. Date: May 1, 2008

(54) BROADBAND ANTENNA

(76) Inventor: I-Fong Chen, Taoyuan City (TW)

Correspondence Address: SINORICA, LLC, 528 FALLSGROVE DRIVE, ROCKVILLE, MD, 20850, US

(21) Appl. No.: 11/554,518

(22) Filed: Oct. 30, 2006

(51) Int. Cl. H04H 20/28

(52) U.S. Cl. 370/487; 342/350; 343/725

(57) ABSTRACT

A broadband antenna applicable to a portable wireless electronic communication product, and especially suitable to be provided on the top or on two sides of a panel, it includes structurally a low-frequency antenna path, a high-frequency antenna path connected with the low-frequency antenna path, and a coaxial cable for feeding out a signal; the core line of the coaxial cable for signal transmission is connected with a signal feed-in point of the antenna, but a grounding line of the coaxial cable is not connected with the antenna to avoid making the coaxial cable a parasitic element of the antenna; the coaxial cable is arranged parallely to the low-frequency antenna path or the high-frequency antenna path, the grounding line of the coaxial cable is used to do perturbation against the transmission path of the antenna, thereby the antenna can get an effect of a broad bandwidth.

### BACKGROUND OF THE INVENTION

1. Field of the Invention

The present invention is related to a broadband antenna used for a portable wireless electronic communication product and provided on the top or on two sides of a panel; and especially to a broadband antenna of which a low-frequency antenna path is connected with a high-frequency antenna path, and of which a coaxial transmission cable is arranged parallely to the low-frequency antenna path or the high-frequency antenna path, the core line of the coaxial cable being connected with a feed-in point of the antenna but a grounding line of the coaxial cable being not connected with the antenna, in order that the antenna can get an effect of a broad bandwidth.

2. Description of the Prior Art

An early wireless transmission communication antenna unit is composed of a cylinder provided therein with a coil having a set length. Such a conventional coil antenna is stable and reliable in emitting and receiving signals, but it is time and work consumptive and cost higher in manufacturing; the largest problem of it is that the antenna is extended out for a set length. Communication units used nowadays include mobile phones and notebooks, most of them are portable electronic products, if an antenna is extended out the surface of a unit, the unit will be inconvenient for carrying or using.

Microstrip antennas have been used in lieu of the conventional coil antennas, this is because that a microstrip antenna has the effect of being suitable for mass production and costing low; the most important advantage of such a microstrip antenna is that the antenna can be planar and miniaturized to be hidden in a portable electronic product for the convenience of carrying on one's person and operating.

A microstrip antenna normally needs a microstrip circuit to be processed and provided on a base board, but by virtue that a communication unit often is required to be applicable to multiple frequencies (for instance, a notebook used on a wireless local network is applicable to 2.4 GHz and 5.2 GHz), hence a related microstrip circuit is probable to be provided on one of the surfaces of a base board, or the microstrip circuit and its related circuits are probable to be provided simultaneously on an upper and a lower surface of a base board. However, no matter which kind of microstrip circuit is used, such microstrip antennas used presently all have only narrower bandwidths and lower irradiation efficiencies, thus improvement is required.

### SUMMARY OF THE INVENTION

The present invention provides a broadband antenna, it includes structurally a low-frequency antenna path, a high-frequency antenna path connected with the low-frequency antenna path, and a coaxial cable for feeding out a signal; the core line of the coaxial cable for signal transmission is connected with a signal feed-in point of the antenna, but a grounding line of the coaxial cable is not connected with the antenna to avoid making the coaxial cable a parasitic element of the antenna; the coaxial cable is arranged parallely to the low-frequency antenna path or the high-frequency antenna path, the grounding line of the coaxial cable is used to do perturbation against the transmission path of the antenna, thereby the antenna can get an effect of a broad bandwidth.

Thus the present invention provides a duo-frequency antenna applicable to a portable wireless electronic communication product and is especially suitable to be provided on the top or on two sides of a panel.

The present invention will be apparent in its structural characteristics and effects of use after reading the detailed description of the preferred embodiment thereof in reference to the accompanying drawings.

### BRIEF DESCRIPTION OF THE DRAWINGS

FIG. 1 is a perspective view of a first embodiment of the present invention;

FIG. 2 is a plane view of a second embodiment of the present invention;

FIG. 3 is a plane view of a third embodiment of the present invention;

FIG. 4 is a plane view of a fourth embodiment of the present invention;

FIG. 5 is a plane view of a fifth embodiment of the present invention;

FIG. 6 is a schematic view showing the present invention being provided on the top or on two sides of a panel;

FIG. 7 is a standing wave voltage ratio (VSWR) diagram showing the result of practical testing when the present invention is applied to a notebook;

FIG. 8 is a chart showing the result of practical testing when the present invention is applied to a notebook expressed by 3D gain efficiencies % under various frequencies.

### DETAILED DESCRIPTION OF THE PREFERRED EMBODIMENT

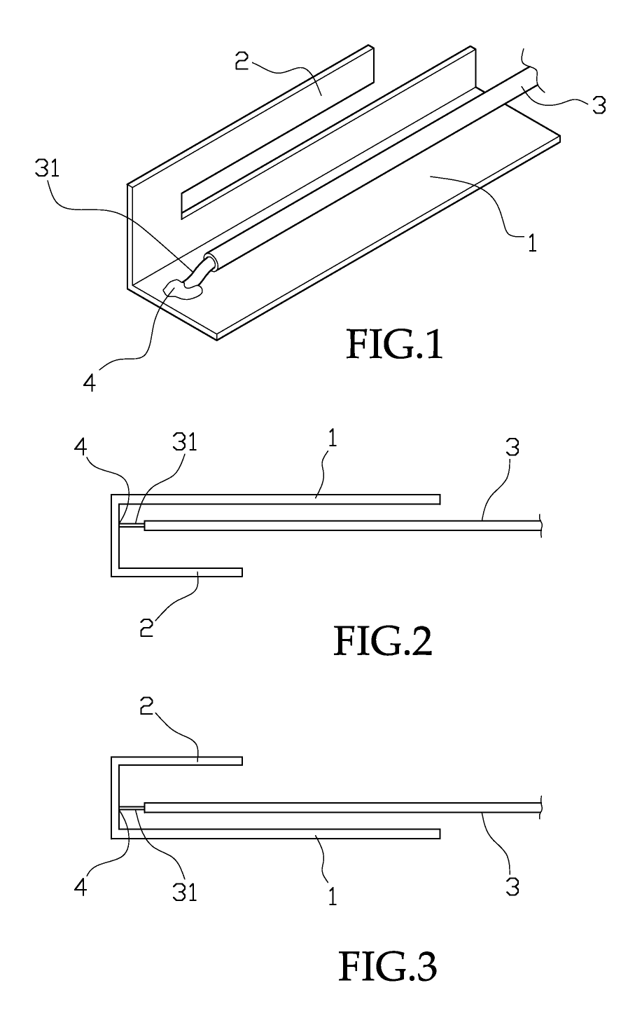

Referring to FIG. 1, a broadband antenna provided by the present invention includes structurally a low-frequency antenna path 1, a high-frequency antenna path 2 connected with the low-frequency antenna path 1, and a coaxial cable 3 of for feeding out a signal.

The range of frequency band used for the antenna is divided into a low-frequency band and a high-frequency band, then ¼ wave lengths (λ/4) of the low- and the high-frequency bands are calculated to be the low-frequency antenna path 1 and the high-frequency antenna path 2.

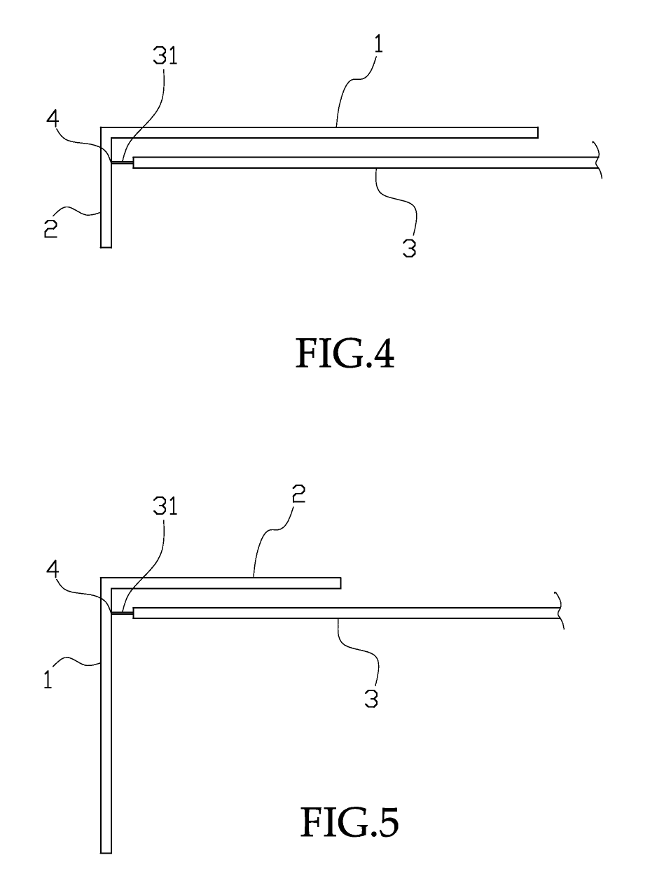

The low-frequency antenna path 1 and the high-frequency antenna path 2 are suitably connected as are shown in FIGS. 1-5; then the coaxial cable 3 is used as a signal transmitting cable to feed out signals.

In connecting of the present invention, a core line 31 for signal transmitting of the coaxial cable 3 is connected with a signal feed-in point 4 of the antenna, but a grounding line of the coaxial cable 3 is not connected with the antenna. When the coaxial cable is connected with the antenna, it is arranged parallely to the low-frequency antenna path 1 or the high-frequency antenna path 2, the grounding line of the coaxial cable 3 is used to do perturbation against the transmission path of the antenna, thereby the antenna can get an effect of a broad bandwidth.

The principle of the present invention is: the grounding line of the coaxial cable 3 is not a standard ground; when it is arranged parallely to the antenna, the coaxial cable 3 becomes a parasitic element of the antenna; this will increase the electric capacity of the antenna structure to thereby form the effect of a broad bandwidth.

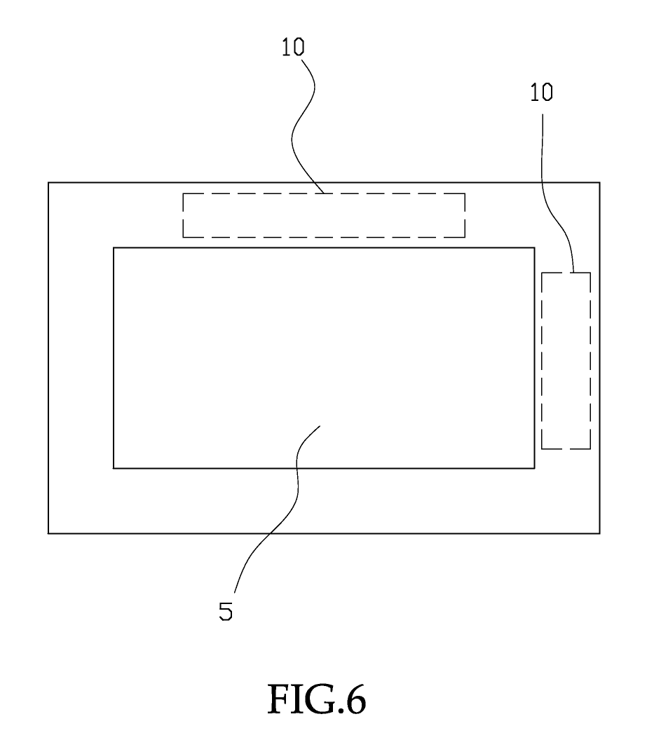

The structure of a broadband antenna 10 provided by the present invention is applicable to a portable wireless electronic communication product, referring to FIG. 6; and is especially suitable to be provided on the top or on two sides of a panel 5.

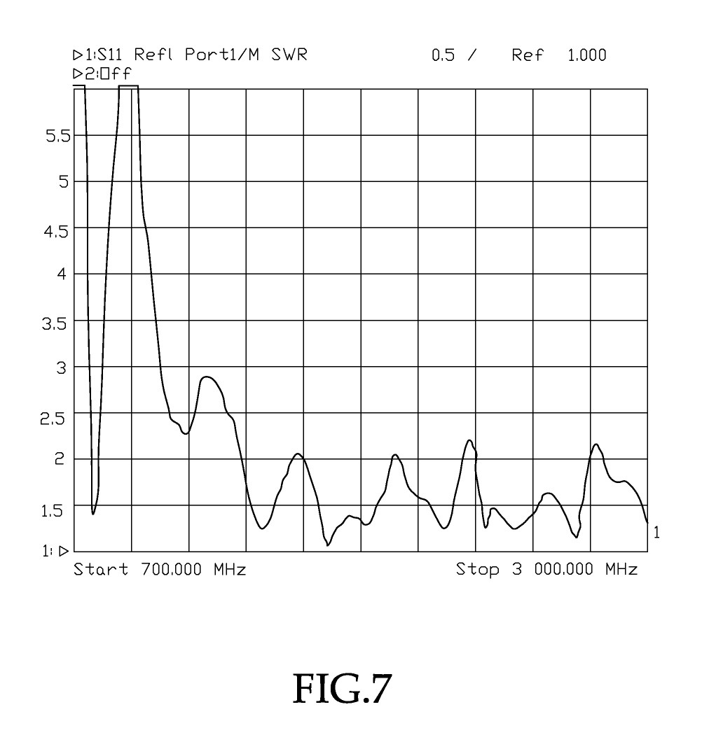

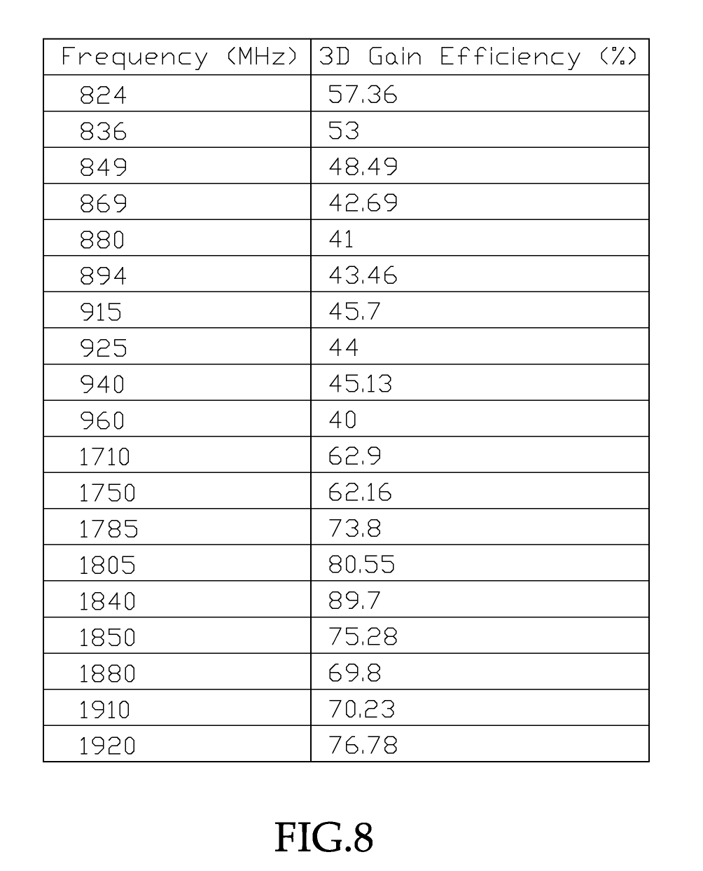

The present invention provides a duo-frequency antenna which is used on a notebook and has the result of practical testing such as is shown in FIGS. 7 and 8, FIG. 7 is a standing wave voltage ratio (VSWR) diagram, and FIG. 8 is a chart expressed by 3D gain efficiencies % under various frequencies. From this test, we can see the antenna is an ideal duo-frequency antenna.

The preferred embodiments disclosed above are only for illustrating the present invention. It will be apparent to those skilled in this art that various modifications or changes made to the elements of the present invention without departing from the spirit of this invention fall within the scope of the appended claims and are intended to form part of this invention.

1. A broadband antenna comprising in structure:
a low-frequency antenna path;
a high-frequency antenna path connected with said low-frequency antenna path; and
a coaxial cable connected with said antenna for signal transmission to feed out a signal;
wherein a core line for signal transmitting of said coaxial cable is connected with a signal feed-in point of said antenna, while a grounding line of said coaxial cable is not connected with said antenna; said coaxial cable is arranged parallely to said low-frequency antenna path or said high-frequency antenna path, said grounding line of said coaxial cable is used to do perturbation against a transmission path of said antenna, thereby said antenna gets an effect of a broad bandwidth.

2. The broadband antenna as defined in claim 1, wherein lengths of said low-frequency antenna path and said high-frequency antenna path are obtained by dividing a range of frequency band used for said antenna into a low-frequency band and a high-frequency band and then calculating to obtain ¼ wave lengths (λ/4) of said low- and said high-frequency bands.

3. The broadband antenna as defined in claim 1, wherein said broadband antenna is adapted to being used on a portable wireless electronic communication product.

4. The broadband antenna as defined in claim 3, wherein said broadband antenna is provided on a top of a panel of a portable wireless electronic communication product.

5. The broadband antenna as defined in claim 3, wherein said broadband antenna is provided on two sides of a panel of a portable wireless electronic communication product.
